(19) United States
(12) Patent Application Publication
(10) Pub. No.: US 2005/0108570 A1
(43) Pub. Date: May 19, 2005

(54) Method, system and program product for obtaining application data

(75) Inventor: Ramajeyam Gopalraj, Nashua, NH (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/717,352

(22) Filed: Nov. 19, 2003

(51) Int. Cl. H04L 9/00

(52) U.S. Cl. 713/201

(57) ABSTRACT

An improved solution for obtaining application data for a network application. The application data is received using a data page displayed to a user during a session with the network application. Prior to submitting the application data to the network application, it is first ensured that the session is valid. In particular, if the session remains valid, then the application data is submitted. However, if the session is no longer valid, then a new session is established prior to the application data being submitted.

### BACKGROUND OF THE INVENTION

1. Technical Field

The invention relates generally to obtaining application data, and more specifically, to a method, system and program product that ensure that a session between a client and a network application is valid before submitting application data entered on the client to the network application.

2. Background Art

Users frequently enter data using a computer and submit this data to a network application located on a server connected over a network, such as the Internet. In order to provide data to the network application, a computer generally establishes a session with the network application. For example, the computer can send a request for a session over the network, and the network application can respond with a session identifier. Once the session has been established, the network application sends one or more pages to the computer, which displays the page(s) to the user. Each page can include any combination of data entry fields such as radio boxes, check boxes, drop down lists, edit boxes, etc. Using the data entry fields, the user can enter in the data. Once all the data has been entered, the user can request that it be sent to the network application by, for example, clicking on a button in the page.

Often, the network application will simultaneously maintain numerous sessions with various computers. However, sessions frequently can terminate unexpectedly due to a loss of communications between the computer and the network application. For example, the computer may lose its connection to the network, lose power, an application may be unexpectedly terminated, etc. Consequently, in order to remove these sessions from the sessions being maintained, the network application will expire a session when no communications are received after a certain period of time. Additionally, when confidential or time-sensitive data is being transferred during a session, the network application may provide a limited time within which data must be submitted from the computer.

Currently, when the network application receives a message from a computer after its session has expired, the network application will reject the message and a new session must be established. For example, the network application can notify the user that the session has expired, and/or provide a login page to allow the user to establish a new session. However, after being redirected to the login page, the page that included the entered data may no longer be available on the computer. In this situation, the data will be lost and the user will be required to reenter the data.

As the data submitted to a network application becomes increasingly complex, the reentry of data becomes increasingly inconvenient to the user. This results in a great deal of frustration to the user. For example, a data page could request shipping information and payment information for an order being placed. While completing the information, the user may become distracted, e.g., receive a telephone call. As a result, once the required information is completed and submitted to the network application, the session could have expired causing the user to be redirected to a login page. In this case, the user will then need to reenter the required information from the beginning.

As a result, a need exists for an improved solution for obtaining application data. In particular, a need exists for a method, system and program product that ensure that a session between a client and network application is valid before submitting application data entered on the client to the network application. In this manner, the application data entered by the user can be preserved if a session expires while it is being entered.

### SUMMARY OF THE INVENTION

The invention provides an improved solution for obtaining application data for a network application. Specifically, under the present invention, a session is established between the network application and a client. One or more data pages are provided to the client which allow a user to enter the application data. Prior to submitting the application data to the network application, it is ensured that the session is valid. In one embodiment, the data page includes instructions that determine a session time remaining when the user requests submission of the application data. If the session time remaining indicates that the session may have expired, and therefore may no longer be valid, the network application can be queried to determine a status of the session. If the session is invalid, then a new session can be established between the network application and client. In any event, once a valid session is ensured, the application data can be submitted to the network application.

A first aspect of the invention provides a method of obtaining application data, the method comprising: obtaining a data page from a network application during a session; receiving the application data using the data page; ensuring that the session is valid; and submitting the application data to the network application when the session is valid.

A second aspect of the invention provides a method of obtaining application data for a network application, the method comprising: establishing a session with a client; providing a data page to the client, wherein the data page ensures that the session is valid before submitting the application data; and receiving the application data from the client.

A third aspect of the invention provides a system for obtaining application data for a network application, the system comprising: a session system for establishing a session with a client; and a data system for providing a data page to the client and receiving the application data from the client; wherein the data page ensures that the session is valid before submitting the application data.

A fourth aspect of the invention provides a program product stored on a recordable medium for obtaining application data, which when executed comprises: program code for receiving the application data using a data page; program code for ensuring that a session with a network application is valid; and program code for submitting the application data to the network application when the session is valid.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for obtaining application data;

FIG. 2 shows an illustrative data page for entering application data;

FIG. 3 shows an illustrative login page for establishing a session;

FIG. 4 shows illustrative method steps for obtaining application data; and

FIG. 5 shows illustrative method steps for ensuring that a session is valid.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for obtaining application data for a network application. Specifically, under the present invention, a session is established between the network application and a client. One or more data pages are provided to the client which allow a user to enter the application data. Prior to submitting the application data to the network application, it is ensured that the session is valid. In one embodiment, the data page includes instructions that determine a session time remaining when the user requests submission of the application data. If the session time remaining indicates that the session may have expired, and therefore may no longer be valid, the network application can be queried to determine a status of the session. If the session is invalid, then a new session can be established between the network application and client. In any event, once a valid session is ensured, the application data can be submitted to the network application.

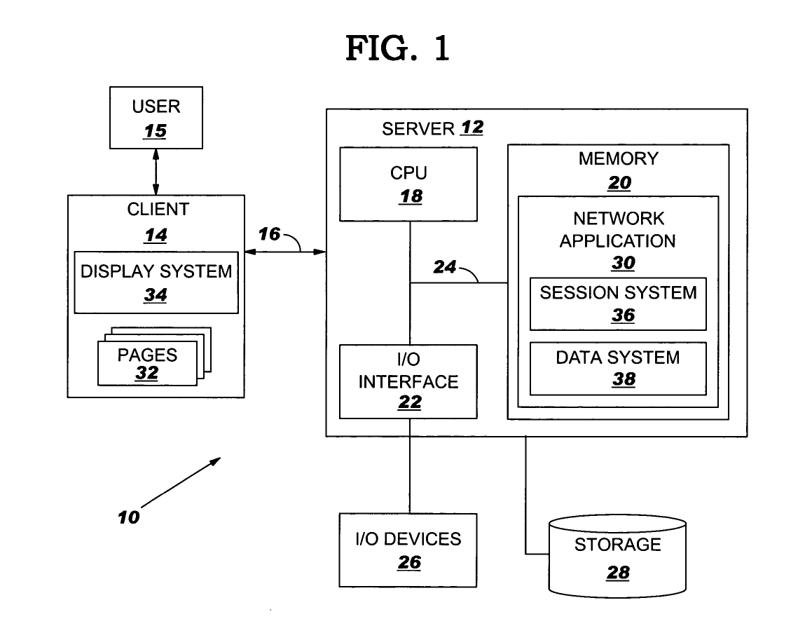

Turning to the drawings, FIG. 1 shows an illustrative system 10 for obtaining application data. In particular, a user 15 enters application data for a network application 30 on a client 14, which communicates the application data to a server 12 over a network 16. To this extent, network 16 can comprise any type of communications link. For example, network 16 can comprise an addressable connection in a client-server (or server-server) environment that may utilize any combination of wireline and/or wireless transmission methods. In this instance, server 12 and client 14 may utilize conventional network connectivity, such as Token Ring, Ethernet, WiFi or other conventional communications standards. Further, network 16 can comprise any type of network, including the Internet, a wide area network (WAN), a local area network (LAN), a virtual private network (VPN), etc. Where client 14 communicates with server 12 via the Internet, connectivity could be provided by conventional TCP/IP sockets-based protocol, and client 14 could utilize an Internet service provider to establish connectivity to server 12.

As shown, server 12 generally includes a central processing unit (CPU) 18, a memory 20, an input/output (I/O) interface 22, a bus 24, external I/O devices/resources 26, and a storage unit 28. CPU 18 may comprise a single processing unit, or be distributed across one or more processing units in one or more locations, e.g., on a client and server. Memory 20 may comprise any known type of data storage and/or transmission media, including magnetic media, optical media, random access memory (RAM), read-only memory (ROM), a data cache, a data object, etc. Storage unit 28 may comprise any type of data storage for providing storage for information necessary to carry out the invention as described below. As such, storage unit 28 may include one or more storage devices, such as a magnetic disk drive or an optical disk drive. Moreover, similar to CPU 18, memory 20 and/or storage unit 28 may reside at a single physical location, comprising one or more types of data storage, or be distributed across a plurality of physical systems in various forms. Further, memory 20 and/or storage unit 28 can include data distributed across, for example, a LAN, WAN or a storage area network (SAN) (not shown).

I/O interface 22 may comprise any system for exchanging information to/from one or more external I/O devices 26. I/O devices 26 may comprise any known type of external device, including speakers, a CRT, LED screen, handheld device, keyboard, mouse, voice recognition system, speech output system, printer, monitor/display, facsimile, pager, communication hardware/software, etc. Bus 24 provides a communication link between each of the components in server 12 and likewise may comprise any known type of transmission link, including electrical, optical, wireless, etc. In addition, although not shown, additional components, such as system software, may be incorporated into server 12.

Further, it is understood that server 12 comprises any type of computing device capable of communicating with one or more other computing devices (e.g., client 14). Similarly, client 14 can comprise any type of computing device, such as a server, a desktop computer, a laptop, a handheld device, a mobile phone, a pager, a personal data assistant, etc. To this extent, client 14 typically includes the same elements as shown in server 12 (e.g., CPU, memory, I/O interface, etc.). These have not been separately shown and discussed for brevity. It is understood, however, that if client 14 is a handheld device or the like, a display could be contained within client 14, and not as an external I/O device 26 as shown for server 12.

Server 12 is shown including a network application 30 that can send one or more pages 32 to client 14. On client 14, display system 34 can display page(s) 32 to user 15. User 15 can use page(s) 32 to provide application data to network application 30. Network application 30 is shown including a session system 36 and a data system 38, which regulate and allow users 15 to provide application data. In particular, session system 36 establishes and maintains sessions with one or more clients 14. When client 14 has a valid session, data system 38 can obtain application data entered by user 15 on client 14. It is understood that some of the various systems shown in FIG. 1 can be implemented independently, combined, and/or stored in memory for one or more separate servers 12 that communicate over a network. For example, session system 36 could be implemented apart from network application 30. Further, it is understood that some of the systems and/or functionality may not be implemented, or additional systems and/or functionality may be included as part of system 10.

As noted previously, data system 38 can obtain application data using one or more pages 32. In particular, data system 38 can provide page(s) 32 to client 14, and display system 34 can display page(s) 32 to user 15 using one or more windows. For example, display system 34 can create a window that displays a first page 32. When a new page 32 is subsequently received by client 14, display system 34 can create a new window to display the new page 32, or use the same window to display the new page 32. In the latter case, the new page 32 can replace the previously displayed page 32 or some or all of both pages 32 can be displayed simultaneously within the window. In one embodiment, display system 34 comprises a browser, while pages 32 comprise web pages.

In order to obtain application data, data system 38 can provide one or more “data pages” to client 14. A data page is a type of page 32 that allows user 15 to enter application data. To this extent, a data page can include a set (one or more) of data entry fields (e.g., radio box, check box, drop down list, edit box, button, etc.), and/or a set of action fields (e.g., submit, cancel, reset, etc.). As a result, user 15 can provide application data using the set of data entry fields, and select a desired action to be performed with the application data using the set of action fields. Depending on the selected action, the application data can be communicated to data system 38.

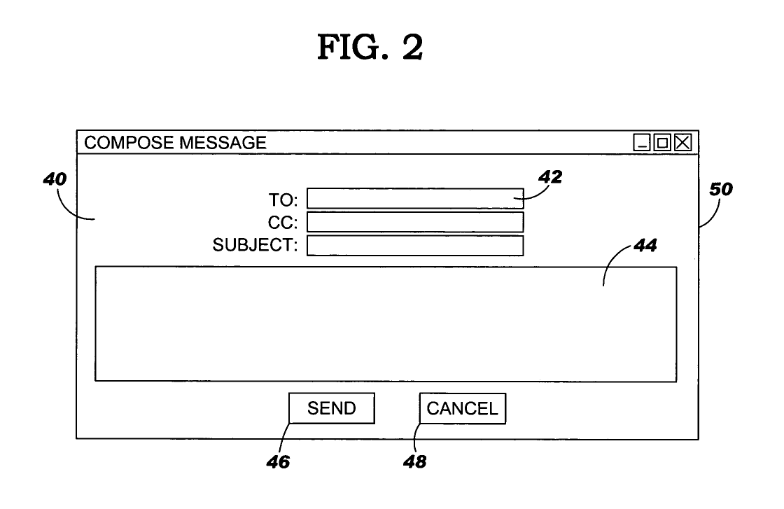

For example, referring now to both FIGS. 1 and 2, FIG. 2 shows an illustrative data page 40 displayed in a window 50 that can be created by display system 34. Data page 40 allows user 15 to provide application data, e.g., compose an electronic message. In particular, data page 40 includes various data entry fields such as a recipient edit box 42 for designating recipient(s) of the electronic message, and a message edit box 44 for entering the content of the electronic message. Further, data page 40 can include various action fields that allow user 15 to specify a desired action to be performed with the electronic message. For example, data page 40 is shown including a send button 46 for sending a completed electronic message, and a cancel button 48 for canceling the electronic message.

Network application 30 may limit access to data page 40. For example, network application 30 may limit the number of users 15 simultaneously providing application data, may allow only certain users 15 to provide application data, etc. To this extent, session system 36 may require that a session be established with client 14 before data page 40 can be provided to client 14. Use of sessions allows network application 30 to limit access to data page 40, and therefore limit users 15 that can submit application data, as desired.

In order to establish a session, session system 36 can require that user 15 provide identification. For example, session system 36 can provide a login page to client 14 that allows user 15 to provide a user name and password. Once entered, the login page can allow user 15 to request that client 14 submit the login data to session system 36 using a “login” action field or the like. Upon receiving the login data from client 14, session system 36 can authenticate the login data by, for example, comparing the received login data to one or more user name/password entries stored in storage unit 28. When the login data is valid (e.g., matches an entry stored in storage unit 28), session system 36 can complete establishing the session with client 14. For example, session system 36 can provide a session identifier to client 14 and/or an initial page 32 that is displayed to user 15 once a session is established.

Network application 30 can have multiple sessions simultaneously established with several clients 14. Since communication between client 14 and server 12 may be unexpectedly terminated, network application 30 may not always receive notification that a client 14 desires to terminate its session. Further, sessions may be terminated after a certain period of inactivity and/or a certain period of time for security reasons, in order to free up temporarily reserved resources, etc. As a result, network application 30 can periodically expire sessions due to inactivity time limitations, or the like.

For example, network application 30 may require that each session have some activity (e.g., communication with network application 30) within thirty minutes from a previous activity in order to remain valid. Assuming data page 40 is provided to client 14 during such a session, user 15 would have approximately thirty minutes to compose the electronic message and submit it to data system 38. Alternatively, user 15 could keep the session valid by performing other actions (e.g., check for new messages using a different page displayed in a different window) while data page 40 is open. In any event, when application data (e.g., the electronic message) is submitted during a valid session, data system 38 will process the submitted application data. Otherwise, network application 30 will reject the application data.

As noted previously, when application data is rejected by network application 30, the application data will need to be reentered by user 15. In order to prevent reentry of the application data, data page 40 can ensure that the session is valid before submitting the application data to network application 30. In one embodiment, data page 40 ensures that the session is valid by determining if the session may have expired. If the session may have expired, then data page 40 can determine if the session remains valid, and if not, establish a new session.

In one embodiment, data page 40 can include a variable that specifies the session time remaining for the session when data page 40 is sent to client 14 for display. For example, the session time remaining can comprise a session time out value that indicates an amount of time within which client 14 must communicate with network application 30 in order to keep the session active. Further, when display system 34 displays data page 40, a display time can be obtained. For example, data page 40 can include instructions that obtain the current time from client 14. Subsequently, user 15 can enter the data for the electronic message and request submission of the electronic message by clicking on send button 46. Upon receiving the submission request, data page 40 can determine a submission time for the submission request. For example, data page can again obtain the current time from client 14. Data page 40 can then calculate the difference between the submission time and the display time, and compare the difference with the session time remaining to determine if the session may no longer be valid.

If the comparison indicates that the session time remaining may have expired, data page 40 can query network application 30 for a session status. For example, the session time remaining may have expired when the difference between the submission time and the display time is greater than or equal to the session time remaining and/or is less than the session time remaining by a threshold amount of time (e.g., five seconds). In any event, if the session time remaining may have expired, data page 40 can query network application 40 by sending a request to network application 30. The request can comprise any command, the response to which will indicate the session status. In one embodiment, the request comprises a background request that does not effect the display of data page 40. In response to the request, network application 30 may respond with an acknowledge reply if the session status remains valid.

When the session status is invalid, network application 30 may respond with a negative acknowledge reply, an error response, or the like. In one embodiment, network application 30 can respond with a login page in order to allow user 15 to establish a new session. In this case, data page 40 can determine that a login page was received and recognize that the session is invalid. For example, the login page could include an attribute that identifies it as a login page. As a result, data page 40 can determine that a login page was received by analyzing the attribute.

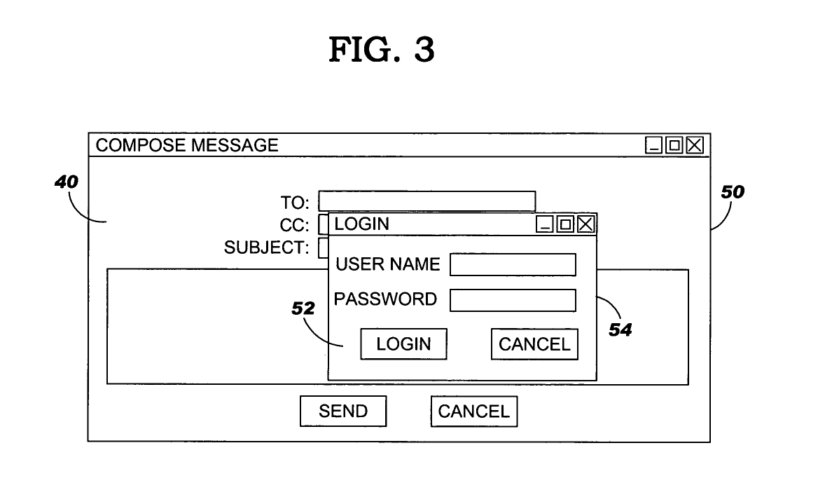

In any event, when data page 40 determines that the session status is invalid, data page 40 can inform user 15, and allow user 15 to establish a new session to submit the application data. When user 15 desires to establish a new session, data page 40 can establish a new session with network application 30. For example, as discussed above, network application 30 may respond to the request with a login page. In this case, display system 34 can display the login page to allow user 15 to enter login data and establish a new session. FIG. 3 shows an illustrative login page 52 that is displayed by display system 34 in a second window 54. By displaying login page 52 in second window 54, the application data entered on data page 40 is retained. As a result, obtaining the login data and submitting the login data to session system 36 does not cause a loss of the application data entered on data page 40. In this manner, a new session can be established without losing application data.

In any event, once data page 40 has ensured that the session is valid, the application data can be submitted to network application 30. Since the session is valid, the application data should be received by data system 38 and processed accordingly. For example, the electronic message created using data page 40 will be forwarded to each recipient designated in recipients text box 42 (FIG. 2). As a result, the risk that the application data will be lost due to an invalid session is substantially reduced.

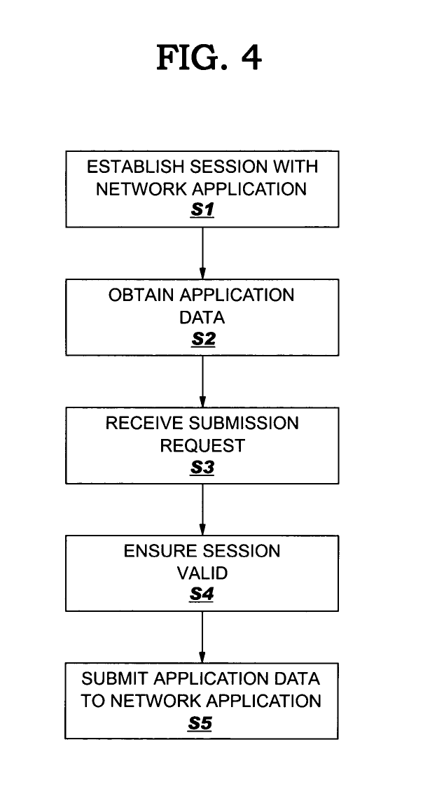

FIG. 4 shows illustrative method steps for obtaining application data that can be performed by the various systems shown in FIG. 1. In step S1, client 14 establishes a session with network application 30. In step S2, application data is obtained using one or more pages 32, and in step S3, a submission request is received from user 15. In step S4, page 32 ensures that there is a valid session with network application 30, and in step S5, the application data is submitted to network application 30 when the session is valid.

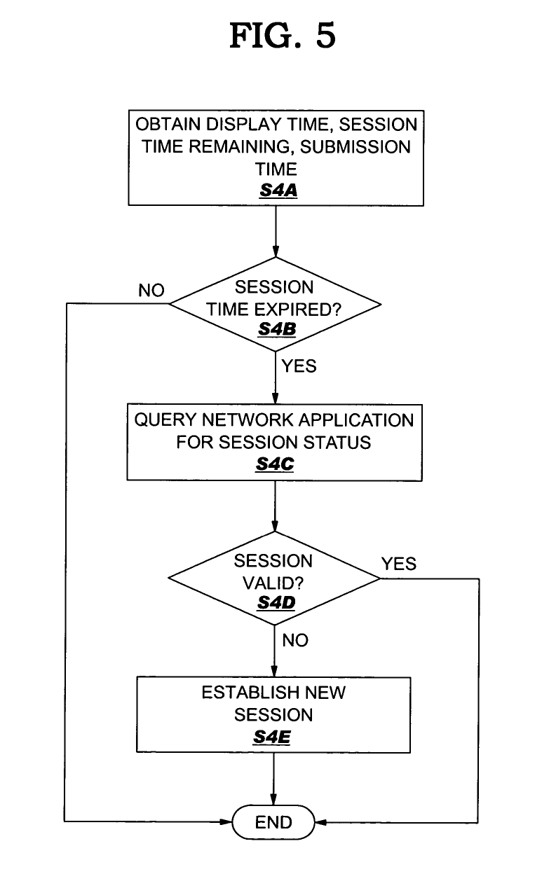

As discussed above, a session may become invalid after a certain amount of time has expired without any communication from client 14. FIG. 5 shows illustrative method steps for ensuring the session is valid in step S4 (FIG. 4) in this case. In step S4A, a page 32 obtains a display time for page 32, a session time remaining at or about the display time, and a submission time when a submission request is received. In step S4B, page 32 determines if the session may have expired using the various times previously obtained. If the session time has not expired, then the session should be valid. However, if the session time may have expired, then in step S4C, page 32 can query network application 30 to determine the status of the session. Based on the results of the query, in step S4D, page 32 can determine if the session is valid. If not, then in step S4E, page 32 can establish a new session with network application 30.

While the invention is discussed with reference to a page 32 and/or a data page 40 (FIG. 2) including instructions for ensuring that the session is valid, it is understood that display system 34 or the like could ensure that the session is valid. For example, display system 34 can determine when data page 40 is displayed, and determine if the session is valid when a submission request is received. In this case, data page 40 can include instructions that request that display system 34 determine if a session is valid. Alternatively, network application 30 can send a message to display system 34 indicating that a session has expired. In this case, if the message is received, display system 34 can establish a new session if a submission request is received. If the message is not received, then there is no communications between client 14 and server 12, and the application data will likely need to be reentered. Still further, display system 34 and/or page 32 can always query network application 30 to determine if a session is valid before processing a submission request.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of obtaining application data, the method comprising:
obtaining a data page from a network application during a session;
receiving the application data using the data page;
ensuring that the session is valid; and
submitting the application data to the network application when the session is valid.

2. The method of claim 1, further comprising establishing the session with the network application.

3. The method of claim 1, further comprising receiving a submission request for the application data.

4. The method of claim 1, wherein the ensuring step comprises:
determining if the session may have expired; and
querying the network application for a session status if the session may have expired.

5. The method of claim 4, wherein the querying step comprises:
sending a request to the network application; and
determining if a login page is received from the network application in response to the request.

6. The method of claim 4, wherein the determining step comprises:
obtaining a session time remaining at a first time;
determining a submission time for the submission request; and
comparing the session time remaining to a difference between the submission time and the first time.

7. The method of claim 6, wherein the first time comprises a display time for the data page.

8. The method of claim 1, wherein the ensuring step comprises establishing another session with the network application if the session is invalid.

9. The method of claim 8, wherein the data page is displayed in a first window, and wherein the establishing step includes displaying a login page in a second window.

10. A method of obtaining application data for a network application, the method comprising:
establishing a session with a client;
providing a data page to the client, wherein the data page ensures that the session is valid before submitting the application data; and
receiving the application data from the client.

11. The method of claim 10, wherein the establishing step comprises:
providing a login page to the client;
receiving login data from the client; and
authenticating the login data.

12. The method of claim 10, further comprising:
receiving a request from the client for an invalid session; and
providing the login page to the client in response.

13. The method of claim 10, wherein the data page includes a session time remaining.

14. The method of claim 13, wherein the data page ensures that the session is valid using the following method steps:
determining a display time for the data page;
determining a submission time for a submission request; and
comparing the session time remaining to a difference between the submission time and the first time.

15. A system for obtaining application data for a network application, the system comprising:
a session system for establishing a session with a client; and
a data system for providing a data page to the client and receiving the application data from the client;
wherein the data page ensures that the session is valid before submitting the application data.

16. The system of claim 15, further comprising a display system for displaying pages to a user.

17. The system of claim 15, wherein the session system provides a login page to the client in response to a request for an invalid session.

18. A program product stored on a recordable medium for obtaining application data, which when executed comprises:
program code for receiving the application data using a data page;
program code for ensuring that a session with a network application is valid; and
program code for submitting the application data to the network application when the session is valid.

19. The program product of claim 18, further comprising program code for receiving a submission request for the application data.

20. The program product of claim 18, wherein the program code for ensuring includes:
program code for determining a display time for the data page;
program code for determining a session time remaining at the display time;
program code for determining a submission time for the submission request; and
program code for comparing the session time remaining to a difference between the submission time and the first time.

21. The program product of claim 20, wherein the program code for ensuring further includes:
program code for sending a request to the network application if the session time remaining may have expired; and
program code for determining if a login page is received from the network application in response to the request.

22. The program product of claim 21, wherein the program code for ensuring further includes program code for displaying the login page in a new window.
